(19) United States
(12) Patent Application Publication
(10) Pub. No.: US 2011/0216337 A1
(43) Pub. Date: Sep. 8, 2011

(54) IMAGE PROCESSING APPARATUS, IMAGE PROCESSING SYSTEM, AND COMPUTER READABLE MEDIUM

(75) Inventor: Yasuhiro ITO, Kanagawa (JP)

(73) Assignee: Fuji Xerox Co., Ltd., Tokyo (JP)

(21) Appl. No.: 12/869,874

(22) Filed: Aug. 27, 2010

(30) Foreign Application Priority Data
Mar. 3, 2010 (JP) 2010-046140

(51) Int. Cl. G06F 3/12

(52) U.S. Cl. 358/1.13

(57) ABSTRACT

An image processing apparatus includes an image output unit, an image acquisition unit, and an image processing execution unit. The image output unit outputs a first image corresponding to content to be printed by a printing unit on a paper medium to an image storage unit. The image acquisition unit acquires a plurality of second images corresponding to read results of content printed on a paper medium by a reading unit. The image processing execution unit performs given image processing for at least one of the second images specified from the plurality of second images based on comparison of the second images and the first images stored in the image storage unit.

### CROSS-REFERENCE TO RELATED APPLICATIONS

This application is based upon and claims priority under 35 USC 119 from Japanese Patent Application No. 2010-046140, filed Mar. 3, 2010.

### BACKGROUND

### Technical Field

The present invention relates to an image processing apparatus, an image processing system, and a computer readable medium.

### SUMMARY OF THE INVENTION

According to an aspect of the invention, an image processing apparatus includes an image output unit, an image acquisition unit, and an image processing execution unit. The image output unit outputs a first image corresponding to content to be printed by a printing unit on a paper medium to an image storage unit. The image acquisition unit acquires a plurality of second images corresponding to read results of content printed on a paper medium by a reading unit. The image processing execution unit performs given image processing for at least one of the second images specified from the plurality of second images based on comparison of the second images and the first images stored in the image storage unit.

### BRIEF DESCRIPTION OF THE DRAWINGS

Exemplary embodiments of the invention will be described in detail based on the following figures, wherein:

FIG. 1 is a diagram showing an example of the hardware configuration of an image processing system according to an exemplary embodiment of the present invention;

FIG. 2 is a functional block diagram showing an example of a function implemented by the image processing system according to an exemplary embodiment of the present invention;

FIG. 3 is a diagram showing an example of specific document information;

FIG. 4 is a flow diagram showing an example of the flow of a process to be performed by the image processing system according to this exemplary embodiment;

FIG. 5 is a flow diagram showing an example of the flow of a process to be performed by the image processing system according to this exemplary embodiment; and

FIG. 6 is a diagram showing an example of specific document correspondence information.

### DETAILED DESCRIPTION

An exemplary embodiment of the present invention will now be described in detail on the basis of the drawings.

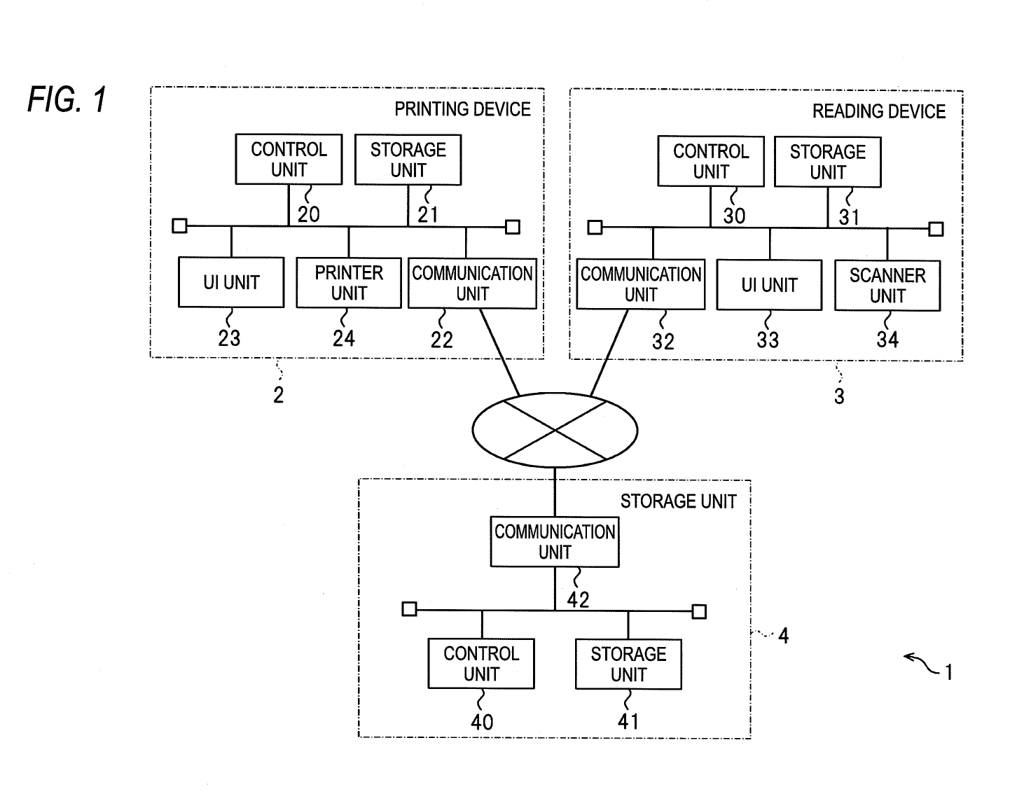

FIG. 1 is a diagram showing an example of the hardware configuration of an image processing system 1 according to this exemplary embodiment. As illustrated in FIG. 1, the image processing system 1 according to this exemplary embodiment includes a printing device 2, a reading device 3, and a storage device 4. The printing device 2, the reading device 3, and the storage device 4 are connected to a communication means such as a LAN, the Internet, or the like, and are communicable with each other.

As illustrated in FIG. 1, for example, the printing device 2 according to this exemplary embodiment is a printer or the like, and includes a control unit 20, a storage unit 21, a communication unit 22, a user interface (UI) unit 23, and a printer unit 24. These elements are connected via a bus. For example, the reading device 3 according to this exemplary embodiment is a scanner or the like, and includes a control unit 30, a storage unit 31, a communication unit 32, a user interface (UI) unit 33, and a scanner unit 34. These elements are connected via a bus. For example, the storage device 4 according to this exemplary embodiment is a storage or the like, and includes a control unit 40, a storage unit 41, and a communication unit 42. These elements are connected via a bus.

The control unit 20 of the printing device 2, the control unit 30 of the reading device 3, and the control unit 40 of the storage device 4 are program control devices such as CPUs or the like, and respectively operate according to programs installed in the printing device 2, the reading device 3, and the storage device 4. The storage unit 21 of the printing device 2, the storage unit 31 of the reading device 3, and the storage unit 41 of the storage device 4 are storage elements such as ROMs, RAMs, or the like, or hard disk drives or the like. Programs to be executed by the control unit 20 of the printing device 2, the control unit 30 of the reading device 3, and the control unit 40 of the storage device 4 are respectively stored in the storage unit 21 of the printing device 2, the storage unit 31 of the reading device 3, and the storage unit 41 of the storage device 4. Also, the storage unit 21 of the printing device 2, the storage unit 31 of the reading device 3, and the storage unit 41 of the storage device 4 respectively operate as work memories of the control unit 20 of the printing device 2, the control unit 30 of the reading device 3, and the control unit 40 of the storage device 4.

The communication unit 22 of the printing device 2, the communication unit 32 of the reading device 3, and the communication unit 42 of the storage device 4 are communication interfaces such as LAN cards or the like, and transmit/receive information to/from other devices.

The UI unit 23 of the printing device 2 and the UI unit 33 of the reading device 3 are constituted by touch panels or liquid crystal displays, input devices (a keyboard, a mouse, and the like), and the like. The UI unit 23 of the printing device 2 and the UI unit 33 of the reading device 3 respectively display screens (for example, a menu screen which prompts a user to input an instruction) based on data input from the control unit 20 of the printing device 2 and the control unit 30 of the reading device 3 according to instructions input from the control unit 20 of the printing device 2 and the control unit 30 of the reading device 3. The UI unit 23 of the printing device 2 and the UI unit 33 of the reading device 3 respectively receive the inputs of the instructions from the user, and output the input content thereof to the control unit 20 of the printing device 2 and the control unit 30 of the reading device 3.

The printer unit 24 of the printing device 2 performs printing on a recording medium such as a paper medium. In this exemplary embodiment, for example, the printer unit 24 forms an image on a recording medium such as a paper medium on the basis of information input from the control unit 20 of the printing device 2.

The scanner unit 34 of the reading device 3 reads content printed on a recording medium such as a paper medium. In this exemplary embodiment, for example, the scanner unit 34 optically performs reading from a surface of the recording medium such as the paper medium, and outputs an image corresponding to read content to the control unit 30 of the reading device 3. According to this exemplary embodiment, the reading device 3 has a tray on which a plurality of paper media is arranged. The scanner unit 34 of the reading device 3 sequentially performs a read-in operation on the plurality of paper media arranged by the user on the tray, generates an image corresponding to each paper medium, and outputs the generated image to the control unit 30 of the reading device 3.

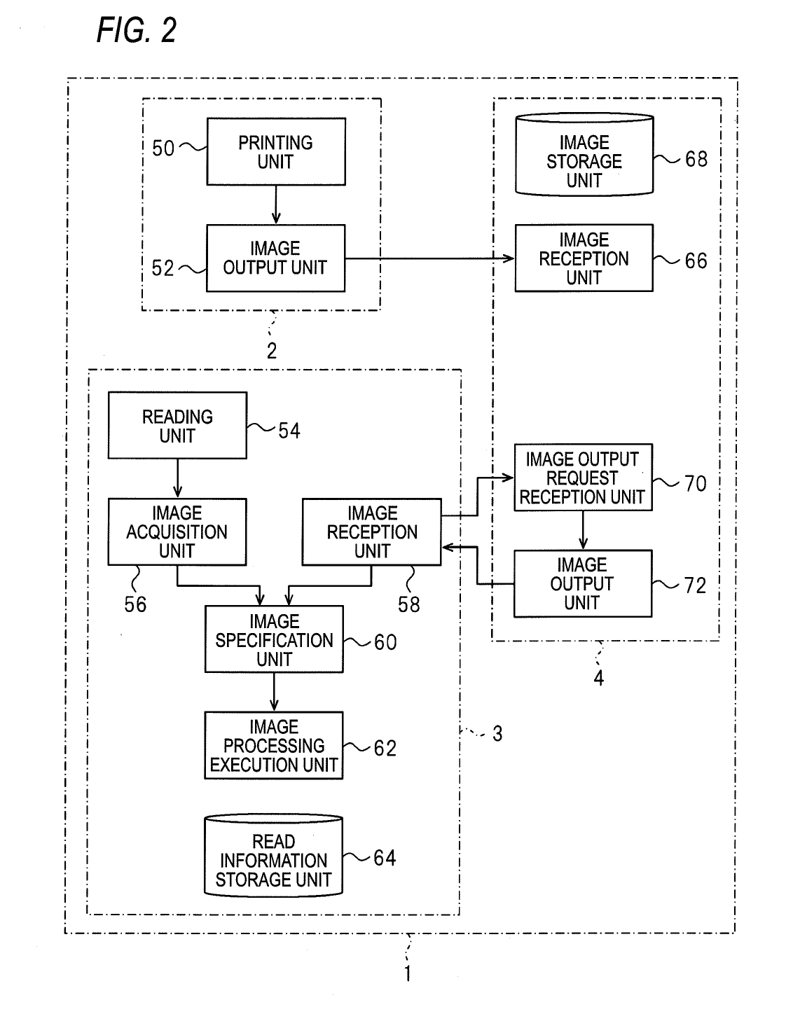

FIG. 2 is a functional block diagram showing an example of a function implemented by the image processing system 1 according to this exemplary embodiment.

As illustrated in FIG. 2, in this exemplary embodiment, for example, the printing device 2 includes a printing unit 50 and an image output unit 52. The printing unit 50 is mainly implemented in the printer unit 24 of the printing device 2. The image output unit 52 is mainly implemented in the control unit 20 and the communication unit 22 of the printing device 2.

For example, the reading device 3 includes a reading unit 54, an image acquisition unit 56, an image reception unit 58, an image specification unit 60, an image processing execution unit 62, and a read information storage unit 64. The reading unit 54 is mainly implemented in the scanner unit 34 of the reading device 3. The read information storage unit 64 is mainly implemented in the storage unit 31 of the reading device 3. The image reception unit 58 is mainly implemented in the control unit 30 and the communication unit 32 of the reading device 3. The other elements are mainly implemented in the control unit 30 of the reading device 3.

For example, the storage device 4 includes an image reception unit 66, an image storage unit 68, an image output request reception unit 70, and an image output unit 72. The image storage unit 68 is mainly implemented in the storage unit 41 of the storage device 4. The other elements are mainly implemented in the control unit 40 and the communication unit 42 of the storage device 4.

These elements are implemented by executing a program installed in the printing device 2, the reading device 3, or the storage device 4 as a computer by the control unit 20 of the printing device 2, the control unit 30 of the reading device 3, or the control unit 40 of the storage device 4. For example, the program is supplied to the printing device 2, the reading device 3, or the storage device 4 via a computer-readable information transfer medium such as a CD-ROM or a DVD-ROM or via a communication means such as the Internet.

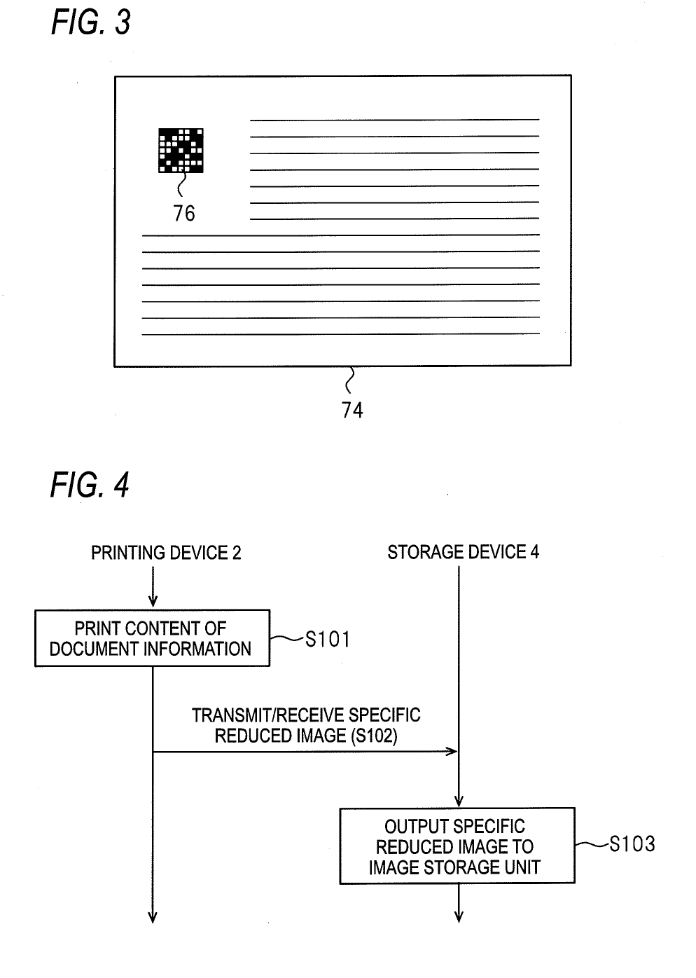

In this exemplary embodiment, for example, the printing device 2 prints a plurality of pages of document information including specific document information 74 illustrated in FIG. 3 in response to a request from the user. The specific document information 74 does not need to be document information of the top page (first page). As illustrated in FIG. 3, in this exemplary embodiment, a two-dimensional code is included within the specific document information 74. For example, the two-dimensional code 76 corresponds to information unique to a plurality of pages of document information (specifically, for example, a server's address, a file name, or the like). Thus, in this exemplary embodiment, a plurality of paper media on which images corresponding to content of a plurality of pages of document information are formed is printed.

In this exemplary embodiment, the user performs a write-in operation on a plurality of paper media on which content of document information is printed. The user causes the reading device 3 to perform a read-in operation on the plurality of paper media for which the write-in operation or the like is performed. A paper medium corresponding to the specific document information 74 is included in the plurality of paper media. The paper medium corresponding to the specific document information 74 does not need to be necessarily read in as a paper medium of the top page (first page).

The reading device 3 generates images (read images) respectively corresponding to paper media by reading from the plurality of paper media. The reading device 3 specifies a specific read image as a read image corresponding to the specific document information 74 from among the generated plurality of read images. For example, the reading device 3 analyzes the two-dimensional code 76 included in a specific read image, and outputs information including information corresponding to the two-dimensional code 76 and the read images respectively corresponding to the plurality of paper media from which reading is performed by the reading device 3 to the read information storage unit 62 as read information.

Here, an example of the flow of a process of causing the image storage unit 68 of the storage device 4 to store an image corresponding to the specific document information 74 to be executed in the image processing system 1 according to this exemplary embodiment will be described with reference to a flow diagram shown in FIG. 4.

First, the printing unit 50 of the printing device 2 prints the content of document information on a paper medium in response to a print request for a plurality of pages of document information serving as a printing target received from a user terminal (not shown) such as a personal computer (S101). The print request may include print-related settings designated by the user. For example, the print request may include information designating whether to print in “black and white” or whether to print in “color”, information indicating a size of a paper medium to be printed (a paper size), information indicating printing by rotation (for example, sideways), information designating the number of paper medium pages to be printed on a paper medium, and the like. The printing unit 50 may print the content of document information on the paper medium according to the settings. The printing unit 50 may print one-page document information on one paper medium, and may print a plurality of pages of document information together on one paper medium.

In this exemplary embodiment, for example, the print request includes information indicating which page of document information is the specific document information 74. More specifically, for example, information (a flag) indicating the specific document information 74 is associated with the specific document information 74.

The image output unit 52 of the printing device 2 outputs (transmits) an image corresponding to the specific document information 74 to the storage device 4, and the image reception unit 66 of the storage device 4 receives the image (S102). Specifically, for example, the image output unit 52 of the printing device 2 generates a specific reduced image as a reduced image (thumbnail image) to which a specific image as an image of a printing result of the specific document information 74 is reduced at a preset reduction ratio, and transmits the generated image to the storage device 4. The image reception unit 66 of the storage device 4 receives the specific reduced image.

The image reception unit 66 of the storage device 4 outputs the specific reduced image received in the process shown in S102 to the image storage unit 68 of the storage device 4 (S103). Thus, the specific reduced image as the image corresponding to the specific document information 74 is stored in the image storage unit 68 of the storage device 4.

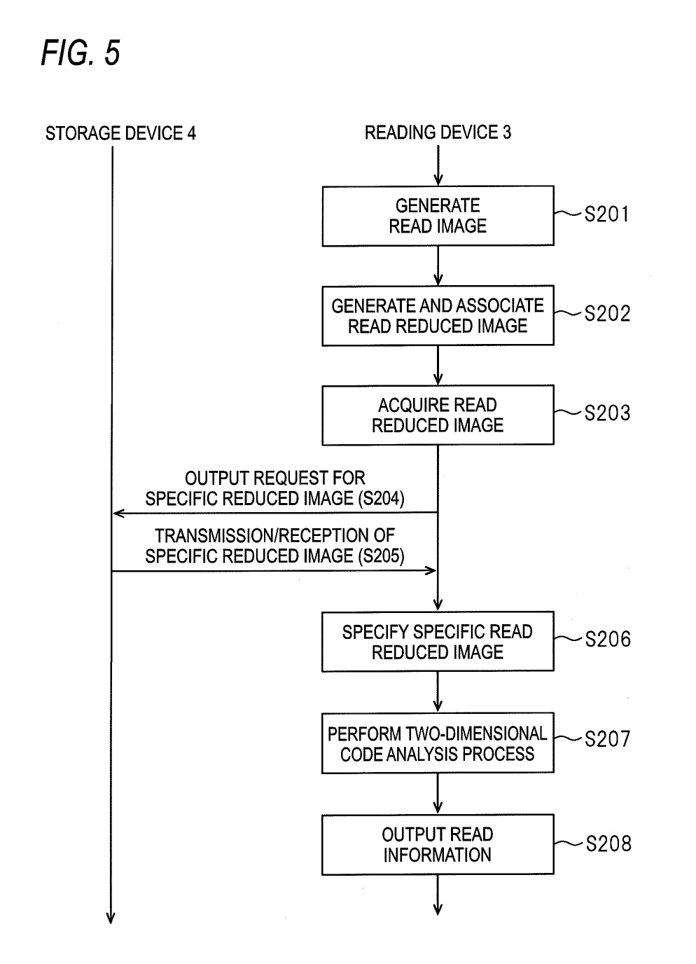

Next, an example of the flow of a read information output process to be performed in the image processing system according to this exemplary embodiment will be described with reference to the flow diagram shown in FIG. 5.

First, the reading unit 54 of the reading device 3 performs a sequential read-in operation on a plurality of paper media arranged on the tray, performs an optical read operation on each paper medium, and generates an image (read image) corresponding to content printed on the paper medium (S201). Here, the reading unit 54 of the reading device 3 may perform reading from the paper medium according to settings received from the user via the UI unit 33 of the reading device 3. For example, the reading unit 54 of the reading device 3 may perform reading from the paper medium according to setting related to a color distribution designated by the user (setting indicating reading in “black and white” or reading in “color”), or resolution-related setting at the time of reading.

The reading unit 54 of the reading device 3 generates a read reduced image as a reduced image (thumbnail image) to which a read image corresponding to each paper medium is reduced (S201), and associates the generated image with a corresponding read image (S202). In this process example, a reduction ratio of a specific reduced image to a specific image is the same as that of a read reduced image to a read image. In this exemplary embodiment, on the basis of content to be printed on one paper medium, the reading unit 54 of the reading device 3 generates one read image and one read reduced image corresponding to the paper medium.

The image acquisition unit 56 of the reading device 3 acquires a plurality of read reduced images generated in the process shown in S202 (S203).

The image reception unit 58 of the reading device 3 transmits a specific reduced image output request to the storage device 4, and the image output request reception unit 70 of the storage device 4 receives the output request (S204). The image output unit 72 of the storage unit 4 outputs (transmits) the specific reduced image to the reading device 3, and the image reception unit 58 of the reading device 3 receives the specific reduced image (S205).

The image specification unit 60 of the reading device 3 specifies a specific read reduced image as a read reduced image corresponding to the specific reduced image received in the process shown in S205 from among the plurality of read reduced images acquired in the process shown in S203 (S206). Specifically, for example, the image specification unit 60 of the reading device 3 calculates a feature quantity of each read reduced image acquired in a process shown in S203 and a feature quantity of the specific reduced image received in a process shown in S205. The image specification unit 60 of the reading device 3 calculates a similarity between a feature quantity of the read reduced image and the specific reduced image on the basis of a comparison result between the feature quantity of the read reduced image and the feature quantity of the specific reduced image by using a known feature quantity comparison method for each read reduced image acquired in the process shown in S203. The image specification unit 60 specifies a read reduced image in which a calculated similarity is highest as a specific read reduced image. In this exemplary embodiment, the image specification unit 60 of the reading device 3 specifies a read reduced image most similar to the specific reduced image as the specific read reduced image.

The image processing execution unit 62 of the reading device 3 performs a two-dimensional code analysis process for a read image (specific read image) associated with the specific read reduced image specified in the process shown in S206 (S207). Specifically, for example, the image processing execution unit 62 of the reading device 3 specifies an area (two-dimensional code arrangement area) where the two-dimensional code 76 is arranged within the specific read image. The image processing execution unit 62 of the reading device 3 generates two-dimensional code correspondence information, which is information corresponding to the two-dimensional code 76 of the two-dimensional code arrangement area, using a known two-dimensional code analysis technology (for example, information unique to document information such as a folder name).

The image processing execution unit 62 of the reading device 3 outputs information including the two-dimensional code correspondence information generated in the process shown in S207 and a plurality of read images generated by the reading unit 54 of the reading device 3 as read information (for example, read document information) to the read information storage unit 64 (S208).

In the process shown in S208, for example, the image processing execution unit 62 of the reading device 3 may output the read information to a folder of a folder name indicated by the two-dimensional code correspondence information.

The present invention is not limited to the above-described exemplary embodiments.

For example, the image output unit 52 of the printing device 2 may generate position information (specifically, for example, a combination of a coordinate value of a top-left end or the like of the two-dimensional code 76 and a width and height of the two-dimensional code 76) indicated by a position of an area where the two-dimensional code 76 is shown within the specific document information 74, associate the position information with the specific reduced image, and output the position information associated with the specific reduced image to the storage device 4. The image processing execution unit 62 of the reading device 3 may specify a position of an area to be occupied by the two-dimensional code 76 within the read specific image on the basis of the position information associated with the specific reduced image, and execute an analysis process for the two-dimensional code 76 for the area.

As described above, the image output unit 52 of the printing device 2 may associate processing content information indicating content of processing for a specific reduced image with the specific reduced image, and output the processing content information associated with the specific reduced image to the storage device 4. For a specific read reduced image, the image processing execution unit 62 of the reading device 3 may execute processing corresponding to the processing content information associated with the specific document correspondence information 78 included in the specific reduced image corresponding to the specific read reduced image specified by the image specification unit 60 of the reading device 3.

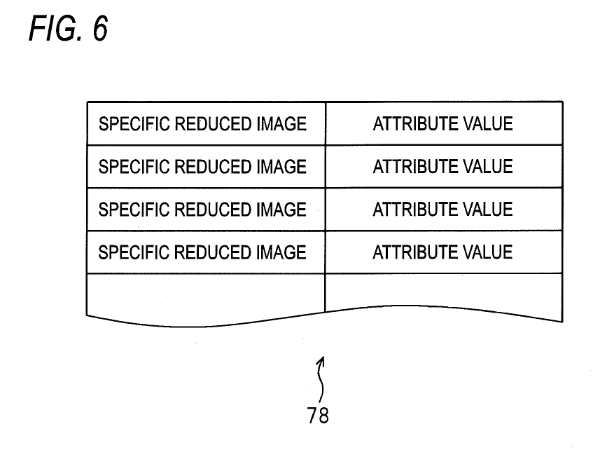

For example, the image output unit 52 of the printing device 2 may generate specific document correspondence information 78 shown in FIG. 6 on the basis of the specific document information 74, and output the specific document correspondence information 78 to the storage device 4. As shown in FIG. 6, for example, the specific document correspondence information 78 includes a plurality of specific reduced images corresponding to one specific document information piece 74. Each specific reduced image is associated with an attribute value of the specific reduced image.

Specifically, for example, the image output unit 52 of the printing device 2 may generate the specific document correspondence information 78 including a plurality of specific reduced images having color distributions different from each other (for example, a specific reduced image of black and white and a specific reduced image of color (for example, 256 colors)), and attribute values (for example, “black and white”, “color”, and the like) indicating the color distributions corresponding to the respective specific reduced images, and output the specific document correspondence information 78 to the storage device 4. For example, the image output unit 52 of the printing device 2 may generate the specific document correspondence information 78 including a plurality of specific reduced images (for example, a specific reduced image and specific reduced images produced by rotating the image by 90 degrees, 180 degrees, and 270 degrees in a clockwise direction) rotated by angles different from each other, and attribute values (for example, 90 degrees, 180 degrees, 270 degrees, and the like) indicating rotation angles corresponding to the respective specific reduced images, and output the specific document correspondence information 78 to the storage device 4. For example, the image output unit 52 of the printing device 2 may generate the specific document correspondence information 78 including a plurality of specific reduced images having resolutions different from each other and attribute values indicating the resolutions corresponding to the respective specific reduced images, and output the specific document correspondence information 78 to the storage device 4. As described above, the image output unit 52 of the printing device 2 may generate a plurality of images (for example, a plurality of specific reduced images) corresponding to one specific document information piece 74, associate the plurality of images to each other, and output the associated images to the storage device 4.

When the reading unit 54 of the reading device 3 performs reading from the paper medium, the image reception unit 58 of the reading device 3 may output an output request for a specific reduced image associated with read setting information indicating settings received from the user to the image output request reception unit 70 of the storage device 4. The image output unit 72 of the storage device 4 may output specific reduced images associated with attribute values corresponding to the read setting information associated with the output request to the reading device 3. The image specification unit 60 of the reading device 3 may specify a specific read reduced image on the basis of comparison results of the specific reduced images and each read reduced image.

For example, the image specification unit 60 of the reading device 3 may specify a specific read reduced image on the basis of a comparison result of a specific reduced image to be included in the specific document correspondence information 78 and each read reduced image.

For example, the image output unit 52 of the printing device 2 may output the specific document correspondence information 78 including a plurality of specific reduced images reduced at reduction ratios different from each other and attribute values indicating paper medium sizes corresponding to the specific reduced images (for example, paper size information indicating paper sizes such as “A4” in this exemplary embodiment) to the storage device 4. When a read image is generated, the reading unit 54 of the reading device 3 may detect a size of a read paper medium (for example, a paper size). The image specification unit 60 of the reading device 3 may specify a specific read reduced image on the basis of a comparison result of a specific reduced image associated with information indicating a paper medium size (for example, a paper size) detected by the reading unit 54 of the reading device 3 and each read reduced image.

For example, the image output unit 52 of the printing device 2 may generate a specific reduced image by reducing an image corresponding to a state in which a plurality of pages of document information including a page of the specific document information 74 is printed on one paper medium, and output the specific reduced image to the storage device 4.

For example, one page of the specific document information 74 or a plurality of pages of the specific document information 74 may be included in a plurality of pages of document information serving as a print target by the printing device 2.

A reduction ratio for a printing result of the specific document information 74 to a specific reduced image may be different from a reduction ratio of a read reduced image to a read image.

The image output unit 52 of the printing device 2 may output a specific image (a full-scale image of a printing result of the specific document information 74) to the storage device 4. The image specification unit 60 of the reading device 3 may specify a specific read image corresponding to a specific image from among a plurality of read images on the basis of a comparison result of a specific image and each read image.

For example, the user causes the reading device 3 to perform a read-in operation on a plurality of paper media including a paper medium of an image corresponding to content of the specific document information 74 among a plurality of paper media printed by the printing device 2 and at least one paper medium on which content different from document information serving as a printing target is written. The image processing execution unit 62 of the reading device 3 may output information including read images corresponding to the plurality of paper media and the two-dimensional code correspondence information generated in the above-described process shown in S207 to the read information storage unit 64 and the like as read information.

For example, in the image processing system 1, a function implemented by any two or more devices of the printing device 2, the reading device 3, and the storage device 4 may be implemented by a single-housing device. Each function implemented in the image processing system 1 may be implemented by a device (for example, a server or the like) different from the printing device 2, the reading device 3, and the storage device 4.

For example, the two-dimensional code correspondence information may be information indicating an address of a server. For example, the image processing execution unit 62 of the reading device 3 may transmit read information to a server indicated by the address indicated by the two-dimensional code correspondence information. The server may receive the read information and output the read information to a storage means such as a hard disk drive provided in the server.

In the above-described process shown in S207, the image processing execution unit 62 may perform image processing (for example, a bar code analysis process or the like) other than the two-dimensional code analysis process.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image output unit that outputs a first image corresponding to content to be printed by a printing unit on a paper medium to an image storage unit;
an image acquisition unit that acquires a plurality of second images corresponding to read results of content printed on a paper medium by a reading unit; and
an image processing execution unit that performs given image processing for at least one of the second images specified from the plurality of second images based on comparison of the second images and the first images stored in the image storage unit.

2. The image processing apparatus according to claim 1,
wherein when the printing unit performs printing an images on the paper medium according to settings received by the printing unit from a user, the image output unit outputs the first image to which the setting is reflected, to the image storage unit.

3. The image processing apparatus according to claim 1,
wherein the image output unit associates the first image with processing content information indicating content of processing for the first image and outputs the first image associated with the processing content information to the image storage unit, and
wherein the image processing execution unit performs processing corresponding to the processing content information for the at least one of the second images.

4. The image processing apparatus according to claim 3,
wherein the image output unit associates the first image with position information indicating a position of an area serving as a target of the image processing within the first image, and outputs the first image associated with the position information to the image storage unit, and
wherein the image processing execution unit performs the image processing for the area corresponding to the position information within the at least one of the second images.

5. The image processing apparatus according to claim 1,
wherein the image output unit further outputs a plurality of images different from each other corresponding to content to be printed on the paper medium to the image storage unit.

6. The image processing apparatus according to claim 5,
wherein the first image is associated with information indicating settings received from a user when the reading unit reads the paper medium,
wherein the reading unit reads content printed on a paper medium according to the settings received from the user, and
wherein the image processing execution unit performs the image processing for the at least one of the second images based on comparison of the second images and the first images stored in the image storage unit associated with the information indicating the settings received from the user.

7. The image processing apparatus according to claim 1,
wherein the image processing execution unit performs the image processing for the at least one of the second images specified based on comparison of the second images and the first image stored in the image storage unit corresponding to a size of a paper medium read by the reading unit.

8. An image processing system comprising:
a printing device includes:
a printing unit that performs printing an image on a paper medium; and
an image output unit that outputting a first image corresponding to content of the image printed on the paper medium to an image storage unit; and
a reading device includes:
a reading unit that reads content printed on a paper medium;
an image acquisition unit that acquires a plurality of second images corresponding to read results of the content printed on the paper medium; and
an image processing execution unit that performs given image processing for at least one of the second images specified from the plurality of second images based on comparison of the second images and the first image stored in the image storage unit.

9. A computer readable medium storing a program causing a computer to execute a process for image processing, the process comprising:
outputting a first image corresponding to content to be printed on a paper medium;
acquiring a plurality of second images corresponding to read results of content printed on a paper medium; and
performing given image processing for at least one of the plurality of second images specified based on comparison of the first image and the second images.

10. The image processing apparatus according to claim 2,
wherein the image output unit associates the first image with processing content information indicating content of processing for the first image and outputs the first image associated with the processing content information to the image storage unit, and
wherein the image processing execution unit performs processing corresponding to the processing content information for the at least one of the second images.

11. The image processing apparatus according to claim 10,
wherein the image output unit associates the first image with position information indicating a position of an area serving as a target of the image processing within the first image, and outputs the first image associated with the position information to the image storage unit, and
wherein the image processing execution unit performs the image processing for the area corresponding to the position information within the at least one of the second images.
